(19) United States
(12) Patent Application Publication
(10) Pub. No.: US 2005/0061587 A1
(43) Pub. Date: Mar. 24, 2005

(54) Brake device having adjustable spring member

(76) Inventor: Shih Fan Tsai, Taichung (TW)

Correspondence Address: Shih Fan Tsai, P.O. Box 63-99, Taichung, 406, TW

(21) Appl. No.: 10/666,414

(22) Filed: Sep. 18, 2003

(51) Int. Cl. B62L 1/06; B62L 5/20

(52) U.S. Cl. 188/24.14; 188/24.22

(57) ABSTRACT

A brake device includes a holder seat for attaching to cycle, one or more brake arms pivotally attached to the holder seat with shafts and each having a brake shoe for braking the cycle. One or more poles are attached to the holder seat, and each includes a stud, and a coil spring is engaged onto each of the shafts and has one end engaged with the brake arm and the other end engaged with the stud of the pole, to apply a spring biasing force against the brake arm and to recover the brake arm. A fastener may be threaded to the holder seat and engageable with the pole, for moving and adjusting the pole and the coil spring relative to the holder seat.

### BACKGROUND OF THE INVENTION

1. Field of the Invention

The present invention relates to a brake device, and more particularly to a brake device for cycles having one or more spring members that may be adjusted to different resilient or spring biasing forces against brake arms.

2. Description of the Prior Art

Various kinds of typical brake devices have been developed and attached to cycles, for braking wheels of the cycles, and comprise a pair of brake arms pivotally attached to the fork devices of the cycles, and a pair of brake shoes attached to the brake arms for braking the wheels of the cycles.

For example, U.S. Pat. No. 5,562,185 to Chen, U.S. Pat. No. 5,740,889 to Tsai, U.S. Pat. No. 5,788,019 to Lee et al., U.S. Pat. No. 5,788,020 to Tseng disclose four of the typical brake devices for cycles, and each comprise a pair of brake arms including one end pivotally attached to the fork devices of the cycles, and a pair of brake shoes attached to the middle portion of the brake arms, and a pair of brake cables coupled to the other ends of the brake arms, for actuating the brake shoes to brake the wheels of the cycles.

Each of the typical brake devices comprises a pair of longitudinal spring rods each having one end pivotally attached to the fork devices of the cycles, and the other end engaged with the middle portions of the brake arms, for recovering the brake arms back to the original position before braking operations. However, the other ends of the longitudinal spring rods have a good chance to be disengaged from the brake arms in use.

U.S. Pat. No. 6,105,733 to Tsai discloses another typical brake device comprising a pair of brake arms including a middle portion pivotally attached to the fork devices of the cycles, and a pair of brake shoes attached to a lower end of the brake arms, and a pair of longitudinal spring rods each having one end pivotally attached to the fork devices of the cycles, and the other end engaged with the lower ends of the brake arms, for recovering the brake arms back to the original position before braking operations. However, the other ends of the longitudinal spring rods may also have a good chance to be disengaged from the brake arms in use.

In addition, the longitudinal spring rods may not be adjusted to different spring biasing force to apply or act onto the brake arms, such that the longitudinal spring rods may not be adjusted to different spring biasing force to actuate the brake arms.

The present invention has arisen to mitigate and/or obviate the afore-described disadvantages of the conventional brake devices for cycles.

### SUMMARY OF THE INVENTION

The primary objective of the present invention is to provide a brake device for cycles including one or more spring members that may be adjusted to different resilient or spring biasing forces against brake arms.

In accordance with one aspect of the invention, there is provided a brake device comprising a holder seat for attaching to cycle, at least one brake arm pivotally attached to the holder seat with a shaft, and including a brake shoe attached thereto for braking the cycle, at least one pole attached to the holder seat, and including a stud provided on one end thereof, and a coil spring engaged onto the shaft, and including a first end engaged with the brake arm, and a second end engaged with the stud of the pole, to apply a spring biasing force against the brake arm and to recover the brake arm.

The holder seat includes at least one oblong hole formed therein to slidably receive the pole, and means for adjusting the pole along the oblong hole of the holder seat, to adjust the spring biasing force of the coil spring applied against the brake arm.

The holder seat includes at least one screw hole formed therein and communicating with the oblong hole thereof, the adjusting means includes a fastener threaded with the screw hole of the holder seat, and engageable with the pole, for moving and adjusting the pole along the oblong hole of the holder seat when the fastener is rotated relative to the holder seat.

The holder seat includes at least one oblong depression formed therein, and communicating with the oblong hole of the holder seat, and the pole includes an enlarged head formed thereon and slidably received in the oblong hole of the holder seat, to guide the pole to stably move along the oblong hole of the holder seat.

The pole includes an enlarged stop panel extended therefrom, to form a peripheral groove therein, and to stably receive and retain the second end of the coil spring relative to the pole. The coil spring includes a hook formed in the second end thereof and having a recess formed therein, to stably receive and retain the stud of the pole therein.

The holder seat includes an oblong hole formed therein, and a fastener slidably engaged in the oblong hole of the holder seat to slidably attach the holder seat to the cycle. The fastener includes a cap threaded thereon and slidably received in the oblong hole of the holder seat. The cap includes at least one flat side surface formed thereon to slidably engage with the holder seat, and to prevent the holder seat from being rotated relative to the cap and the fastener. A retaining ring may be attached to the pole, and engaged with the holder seat, for securing the pole to the holder seat.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a brake device for cycles in accordance with the present invention;

FIG. 2 is a perspective view of the brake device for cycles;

FIG. 3 is a partial cross sectional view taken along lines 3-3 of FIG. 2;

FIG. 4 is a partial cross sectional view similar to FIG. 3, illustrating the operation of the brake device for cycles;

FIGS. 5, 6 are enlarged partial cross sectional views of that shown in FIGS. 3 and 4 respectively, illustrating the operation of the brake device for cycles;

FIG. 7 is a plan schematic view illustrating the other arrangement of the brake device for cycles; and

FIG. 8 is a plan schematic view similar to FIG. 7, illustrating a further arrangement of the brake device for cycles.

### DETAILED DESCRIPTION OF THE PREFERRED EMBODIMENT

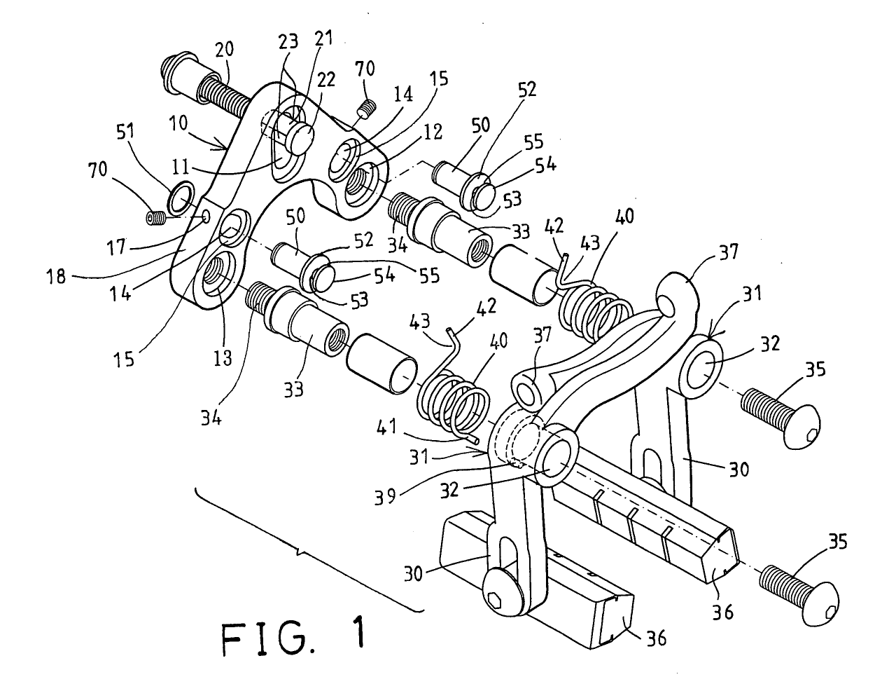

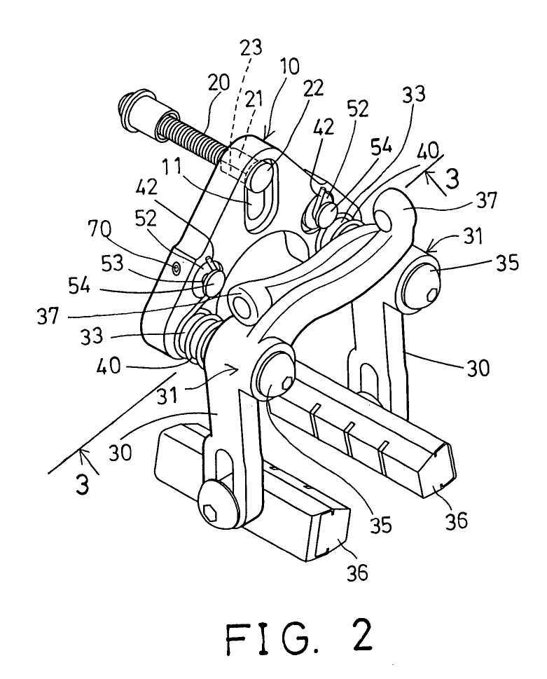

Referring to the drawings, and initially to FIGS. 1-3, a brake device in accordance with the present invention is primarily provided for attaching to such as cycles, and comprises a holder seat 10 including an oblong hole 11 formed in the middle portion thereof for slidably receiving a fastener 20 which may be secured to fork devices or frames of the cycles (not shown), and thus for adjustably securing the holder seat 10 to the cycles.

A cap 21 is threaded to one end of the fastener 20, and includes an enlarged head 22 formed or provided on one end of the cap 21, for engaging with the holder seat 10, and for retaining the holder seat 10 to the fastener 20, and for preventing the holder seat 10 from being disengaged from the fastener 20. The cap 21 includes one or more flat side surfaces 23 formed thereon for engaging with the holder seat 10, and for preventing the holder seat 10 from being rotated relative to the cap 21 and the fastener 20.

The holder seat 10 includes one or more, such as two screw holes 12, 13 formed therein, such as formed in two ends thereof. One or more, such as two brake arms 30 each includes a middle portion 31 having an orifice 32 formed therein for rotatably receiving a shaft 33 therein, and each of the shafts 33 includes a threaded portion 34 for threading with the screw holes 12, 13 of the holder seat 10, and thus for rotatably or pivotally attaching the brake arms 30 to the holder seat 10.

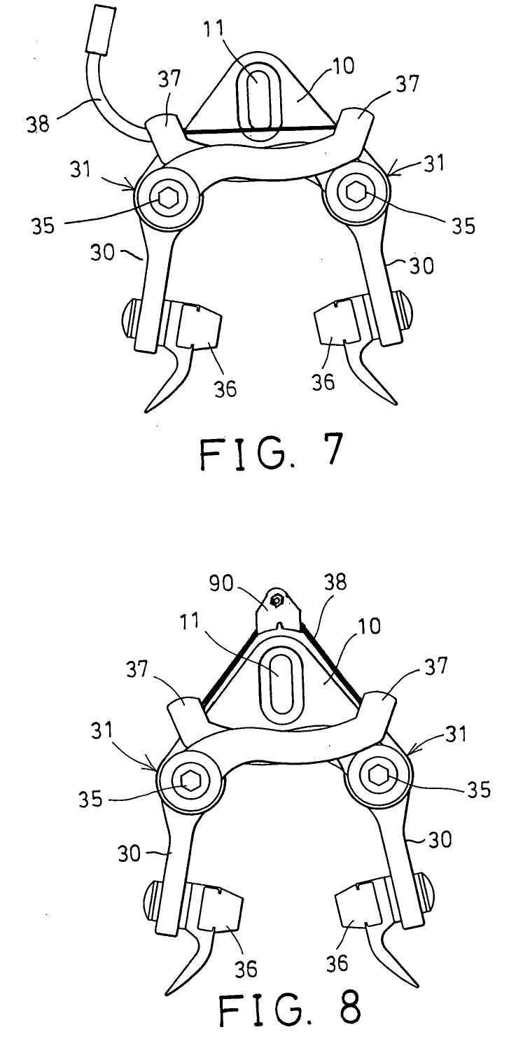

One or more, such as two fasteners 35 may be threaded to the shafts 33 respectively, and may be engaged with the middle portions 31 of the brake arms 30, for stably and rotatably retaining the middle portions 31 of the brake arms 30 on the shafts 33 respectively. Each of the brake arms 30 includes a lower portion having a brake shoe 36 attached thereto, for braking the wheels of the cycles; and includes an upper portion 37 for coupling to brake cables 38 (FIGS. 7, 8).

In operation, two brake cables 38 may be coupled to the upper portions 37 of the brake arms 30 respectively, for actuating or operating the brake arms 30 to force the brakes shoes 36 to conduct the braking operations respectively. Alternatively, as shown in FIG. 7, one brake cable 38 may be engaged through the upper portion 37 of one of the brake arms 30 and coupled to the upper portion 37 of the other brake arms 30 for actuating or operating the brake arms 30 simultaneously.

Further alternatively, as shown in FIG. 8, the upper portions 37 of the brake arms 30 may be coupled to a coupler 90 with a cable 38, for allowing the brake arms 30 to be actuated or operated by the other brake cables (not shown) with the coupler 90 simultaneously. The operation or the actuation of the brake arms 30 by the brake cables is not related to the present invention and will not be described in further details.

Two coil springs 40 are engaged onto the shafts 33 respectively. Each of the brake arms 30 includes a cavity 39 formed in the middle portion 31 thereof (FIG. 1), to receive one end 41 of the coil springs 40 respectively. Each of the coil springs 40 includes a hook 42 formed or provided on the other end thereof, and having a recess 43 formed therein.

The holder seat 10 includes one or more, such as two oblong holes 14 formed therein, such as formed in the two ends thereof, and located close to, but spaced away from the screw holes 12, 13 thereof respectively, for slidably receiving two poles 50 therein respectively. Each of the poles 50 includes a retaining ring 51 attached to one end thereof, for slidably securing the poles 50 to the holder seat 10, and an enlarged head 52 provided on the other end thereof, for engaging with the holder seat 10, and for preventing the poles 50 from being disengaged from the holder seat 10.

The holder seat 10 further includes one or more, such as two oblong depressions 15 formed therein, and communicating with the oblong holes 14 respectively, for slidably receiving the enlarged head 52 of the poles 50 therein respectively, and for positioning the poles 50 to the holder seat 10, and for stably guiding the poles 50 to move or to be adjusted along the oblong holes 14 of the holder seat 10 respectively.

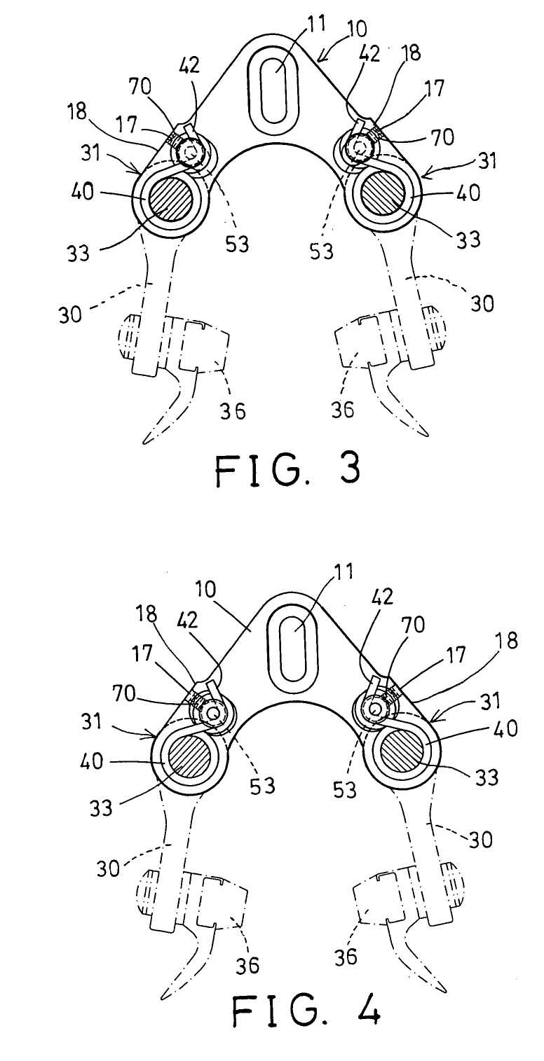

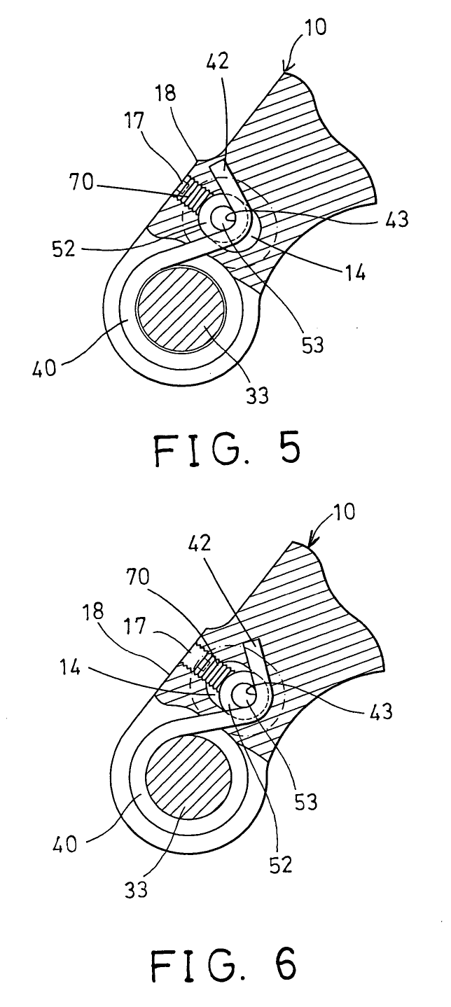

Each of the poles 50 further includes a stud 53 extended outwardly from the other end or the enlarged head 52 thereof, and an enlarged stop panel 54 extended radially and outwardly from the free end of the stud 53, for forming or defining a peripheral groove 55 therein, or between the enlarged head 52 and the enlarged stop panel 54, and for receiving the hook 42 of the coil springs 40 respectively, and for allowing the stud 53 to be stably received in the recesses 43 of the coil springs 40 respectively (FIGS. 3-6).

The holder seat 10 further includes one or more, such as two screw holes 17 formed in the outer peripheral surface 18 thereof, and communicating with the oblong holes 14 thereof respectively, for threading with another fastener 70. As best shown in FIGS. 3-6, the fastener 70 may be threaded or adjusted or moved into the oblong holes 14 of the holder seat 10, and may be engaged with the poles 50 respectively, for moving or adjusting the poles 50 against the coil springs 40 respectively, and thus for adjusting the coil springs 40 to apply different spring biasing forces onto or against the brake arms respectively.

Accordingly, the brake device in accordance with the present invention includes one or more spring members that may be adjusted to different resilient or spring biasing forces against brake arms.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A brake device comprising:
a holder seat for attaching to a bicycle, said holder seat including at least one oblong hole formed therein, and including at least one screw hole formed therein and communicating with said at least one oblong hole thereof,
at least one brake arm pivotally attached to said holder seat with a shaft, and including a brake shoe attached thereto for braking the cycle,
at least one pole attached to said holder seat, and slidably received in said at least one oblong hole of said holder seat, and including a stud provided on one end thereof,
a coil spring engaged onto said shaft, and including a first end engaged with said at least one brake arm, and a second end engaged with said stud of said at least one pole, to apply a spring biasing force against said at least one brake arm and to recover said at least one brake arm, and
a fastener threaded with said at least one screw hole of said holder seat, and engageable with said at least one pole, for moving and adjusting said at least one pole along said at least one oblong hole of said holder seat when said fastener is rotated relative to said holder seat, and to adjust the spring biasing force of said coil spring applied against said at least one brake arm.

2-3. (canceled).

4. The brake device as claimed in claim 1, wherein said holder seat includes at least one oblong depression formed therein, and communicating with said at least one oblong hole of said holder seat, and said at least one pole includes an enlarged head formed thereon and slidably received in said at least one oblong hole of said holder seat, to guide said at least one pole to stably move along said at least one oblong hole of said holder seat.

5. The brake device as claimed in claim 1, wherein said at least one pole includes an enlarged stop panel extended therefrom, to form a peripheral groove therein, and to stably receive and retain said second end of said coil spring relative to said at least one pole.

6. The brake device as claimed in claim 1, wherein said coil spring includes a hook formed in said second end thereof and having a recess formed therein, to stably receive and retain said stud of said at least one pole therein.

7. The brake device as claimed in claim 1, wherein said holder seat includes an oblong hole formed therein, and a fastener slidably engaged in said oblong hole of said holder seat to slidably attach said holder seat to the cycle.

8. The brake device as claimed in claim 7, wherein said fastener includes a cap threaded thereon and slidably received in said oblong hole of said holder seat.

9. The brake device as claimed in claim 8, wherein said cap includes at least one flat side surface formed thereon to slidably engage with said holder seat, and to prevent said holder seat from being rotated relative to said cap and said fastener.
